(19) United States
(12) Patent Application Publication
(10) Pub. No.: US 2014/0152743 A1
(43) Pub. Date: Jun. 5, 2014

(54) ADJUSTABLE PRINT HEAD

(71) Applicant: Videojet Technologies Inc., Wood Dale, IL (US)

(72) Inventors: George Murad, Bartlett, IL (US); Paul Sage, Lindenhurst, IL (US)

(21) Appl. No.: 13/924,831

(22) Filed: Jun. 24, 2013

Related U.S. Application Data
(62) Division of application No. 12/245,312, filed on Oct. 3, 2008, now abandoned.

(51) Int. Cl. B41J 2/175

(52) U.S. Cl. CPC B41J 2/175
USPC 347/85

(57) ABSTRACT

An adjustable print head assembly for an ink jet printer includes a first member and a second member. The first member includes an outer wall and an inner passage. The second member includes an outer wall and an inner passage, the outer wall including an angled surface complementary to the angled surface of the first member. A print head is connected to the second member. At least one ink line runs from the umbilical to the print head, and is disposed through the inner passages of the first and second members. The print head assembly is adjustable from a first configuration to a second configuration, wherein in the first configuration, the print head axis is oriented generally parallel to the umbilical axis, and in the second configuration, the print head axis is oriented at a predetermined angle with respect to the umbilical axis.

### CROSS-REFERENCE TO RELATED APPLICATIONS

This application is a divisional of U.S. application Ser. No. 12/245,312, filed on Oct. 3, 2008, the entire disclose of which is herein incorporated by reference.

### BACKGROUND OF THE INVENTION

Ink jet printers are used in a variety of applications to apply text or an image to a substrate. A typical ink jet printer includes a cabinet, a print head, and an umbilical running from the cabinet to the print head. Existing non-contact ink jet print heads are pre-configured to a fixed geometry, typically either straight (180°) or right-angle (90°). These print head configurations work for known suitable applications; however, they do not work with all mounting applications. Therefore, the user must determine what print head geometry best fits a specific application. In some applications, the user may have the need to keep two different printers, because one application may require one print head geometry while the other application requires a different print head geometry.

### BRIEF SUMMARY OF THE INVENTION

The present disclosure provides an adjustable print head that can be configured as a straight or any desired angled print head.

In one embodiment, an adjustable print head assembly for an ink jet printer includes an umbilical of an ink jet printer with a center axis. A hub is connected to the umbilical. A first member is connected to the hub, the first member including an outer wall and an inner passage. The outer wall includes a proximal end connected to the hub and a distal end with an outer surface angled with respect to the umbilical axis. A second member includes an outer wall and an inner passage, the outer wall including an angled surface complementary to the angled surface of the first member. A print head is connected to the second member, the print head including a center axis. At least one ink line runs from the umbilical to the print head, and is disposed through the inner passages of the first and second members. The print head assembly is adjustable from a first configuration to a second configuration, wherein in the first configuration, the print head axis is oriented generally parallel to the umbilical axis, and in the second configuration, the print head axis is oriented at a predetermined angle with respect to the umbilical axis, wherein the predetermined angle is between 10° and 170°.

In another embodiment, a method of changing the orientation of an adjustable print head assembly for an ink jet printer includes providing a print head assembly for an ink jet printer. The print head assembly includes a hub connected to an umbilical of the ink jet printer, a first member connected to the hub, and a second member connected to the first member. A print head is connected to the second member. The print head assembly is in a first configuration with a center axis of the print head axis oriented generally parallel to a center axis of the hub axis. At least one ink line runs from the umbilical to the print head through the first and second members. A fastener connecting the first member to the second member is removed. The first member is rotated with respect to the second member. A fastener is attached to connect the first member to the second member to provide a second configuration wherein the print head axis is oriented at a predetermined angle with respect to the hub axis, wherein the predetermined angle is between 10° and 170°.

### BRIEF DESCRIPTION OF THE DRAWINGS

FIG. 1 is an isometric view of an embodiment of a print head assembly in a first configuration.

FIG. 2 is an isometric view of the print head assembly of FIG. 1 in a second configuration.

FIG. 3 is an isometric view of an embodiment of a print head assembly with the cover removed.

FIG. 4 is a side view of the print head assembly of FIG. 3.

FIG. 5 is a bottom view of the print head assembly of FIG. 3.

FIG. 6 is a sectional view along line 6-6 of FIG. 5.

FIG. 7 is an isometric view of components of the print head assembly of FIG. 3

FIG. 8 is an isometric view of a first member of the print head assembly of FIG. 3.

FIG. 9 is an isometric view of a second member of the print head assembly of FIG. 3.

### DETAILED DESCRIPTION OF THE INVENTION

The present disclosure provides an adjustable print head that can be configured as a straight or angled print head. With this print head functionality, the print head can be utilized in any application. The user of the adjustable print head only needs to stock one printer as a spare; if a printer fails, the adjustable print head of the spare printer can be converted to the same configuration as the failed printer, whether the print head is in a straight or angled orientation. Thus, the user can keep the line running without the need to stock more than one spare printer. Thus, the adjustable print head assembly reduces the number of spare parts and stocking numbers necessary.

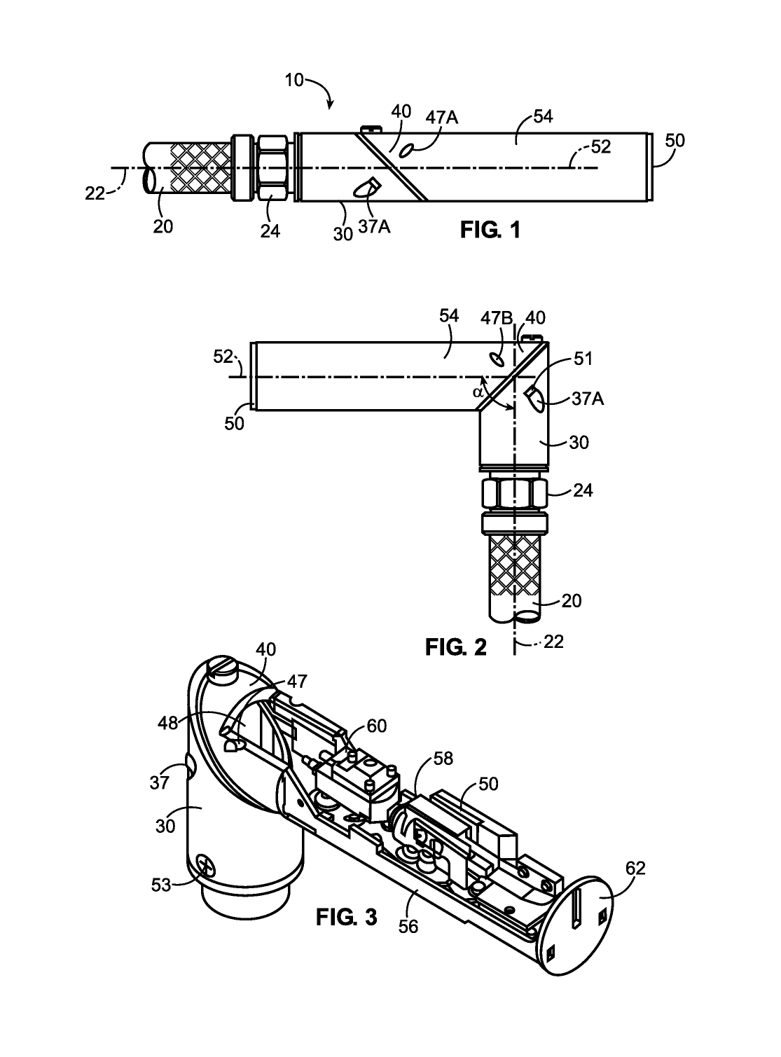

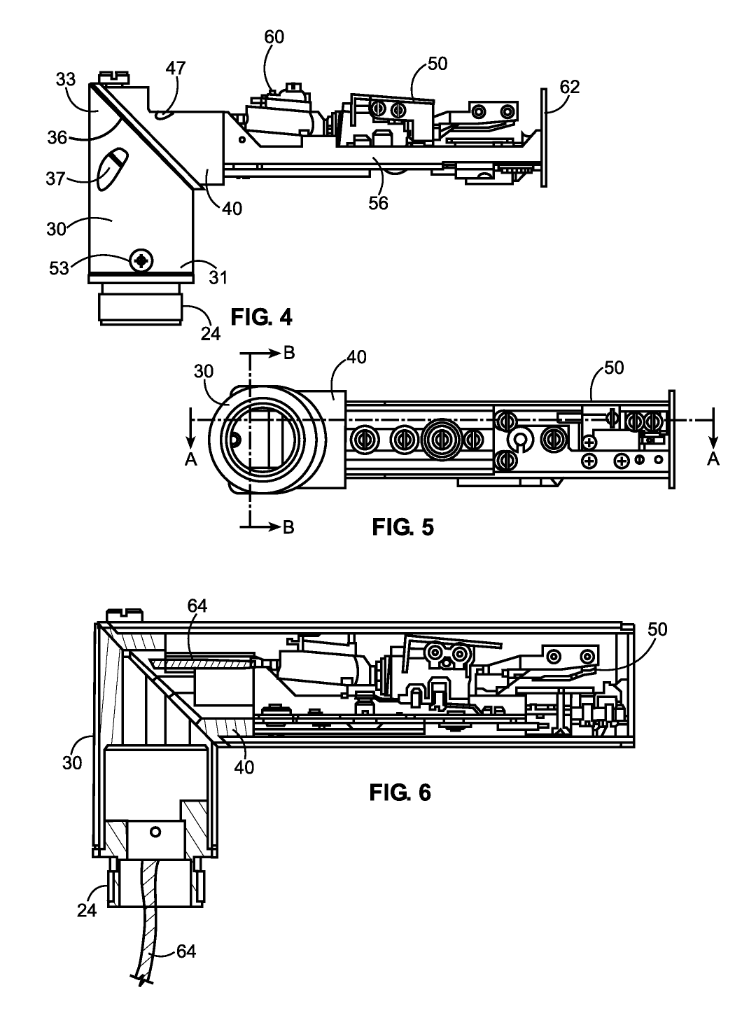

FIGS. 1 and 2 show the adjustable print head assembly 10 for an ink jet printer in a straight configuration and 90° configuration, respectively. The umbilical 20 of an ink jet printer includes a center axis 22. The center axis 22 is understood to be disposed through the umbilical 20 and is used in reference to the orientation of the print head 50. A hub 24 is connected to the umbilical 20. The hub 24 provides an attachment point between the print head 50 and the umbilical 20.

The print head assembly 10 uses members 30, 40 to provide an adjustable print head. The first member 30 is connected to the hub 24 by a suitable connection. For example, hub 24 may be threaded into the first member 30. A fastener 53, such as a screw or other methods, may also be used for connecting member 30 to the hub 24. The second member 40 is connected to the print head 50. The print head 50 includes a center axis 52. The print head assembly 10 is adjustable from a first configuration to a second configuration. In the first or straight configuration, the print head axis 52 is oriented generally parallel to the umbilical axis 22. In the second or angled configuration, the print head axis 52 is oriented at a predetermined angle a with respect to the umbilical axis. The predetermined angle a is between 10° and 170°. In another embodiment, the predetermined angle a is between 45° and 135°. In a further embodiment, the predetermined angle a is between 80° and 100°. In a preferred embodiment, the predetermined angle a is about 90°.

The print head assembly 10 preferably includes a print head 54 cover disposed over the print head 50. FIG. 3 shows the print head assembly with the print head cover 54 removed. The print head cover 54 may be in the general shape of a cylinder and slide over print head chassis 56. Although the present adjustable print head design may be used with any suitable print head, print head 50 includes, for example, nozzle assembly 58, ink valve 60, and orifice plate 62. As shown in FIG. 6, at least one ink line 64 runs from the umbilical 20 to the print head 50. The ink line 64 is disposed through the inner passages of the first and second members 30, 40. In addition to ink line 64, other fluid lines are possible, including solvent, return, and vacuum lines.

As shown in FIGS. 5, 6, and 9, the first member 30 includes an outer wall 32 and an inner passage 34. The outer wall includes a proximal end 31 connected to the hub 24 and a distal end 33 with an outer surface angled 36 with respect to the umbilical axis 22. The member 30 is generally cylindrical in shape with a proximal end 31 including a straight surface and the distal end 33 including an angled surface 36. The inner passage 34 is disposed between the proximal end 31 and the distal end 33. The inner passage 34 may be any suitable shape for allowing placement of various lines through the member 30, such as ink, solvent, and vacuum lines. Additionally, member 30 may include features such a holes for attachment, threads, and so forth. In particular, holes or channels 37 may be used for attachment of member 30 to member 40.

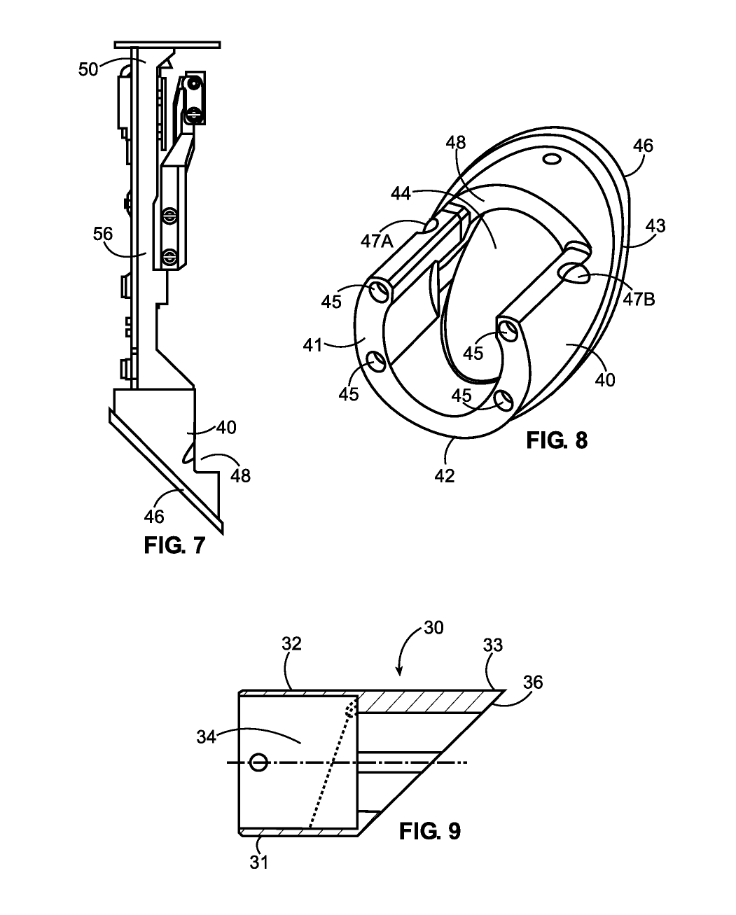

A shown in FIG. 8, the second member 40 includes an outer wall 42 and an inner passage 44. The outer wall 42 includes a surface 46 angled with respect to the print head axis 52 and complementary to the angled surface 36 of the first member 30. The member 40 is generally cylindrical in shape with a first end 41 including a straight surface and the second end 43 including an angled surface 46. The inner passage 44 is disposed between the first end 41 and the second end 43. The inner passage 44 may be any suitable shape for allowing placement of various lines through the member 40, such as ink, solvent, and vacuum lines. The embodiment shown in FIG. 8 includes a cutout portion 48 to allow access to some of the components of the print head, as best seen in FIG. 3. Member 40 may include features such a holes 45 for attachment to the print head chassis 56 (as further shown in FIG. 7), and holes or channels 47 to facilitate attachment of member 40 to member 30.

In a typical application, the print head assembly 10 is adjustable from a straight orientation to a 90° orientation. However, as previously noted, other print head orientations are possible. The angular relationship between member 30 and member 40 may be controlled to provide other print head orientations. In particular, by changing the angle of outer surface 36 with respect to the umbilical axis 22 and the angle of surface 46 with respect to the print head axis 52, virtually any combination of orientations may be obtained.

The print head assembly 10 may include fasteners or other methods for connecting the first member 30 to the second member 40. The first member 30 may include channels 37 disposed generally perpendicular to the angled surface 36 of the first member. The second member 40 may include channels 47 disposed generally perpendicular to the angled surface 46 of the second member 40. In particular, fasteners 51 may be disposed through channels 37 in member 37 and fastened in threaded channels 47 in member 40. It will be apparent that other configurations are possible for providing suitable attachment between members 30 and 40.

During the movement of the print head assembly 10 from one configuration to the other, the fastener channels 37A, 37B of member 30 switch which fastener channels 47A, 47B they are adjacent to in member 40. Fastener channels 37A, 37B are disposed on opposite sides of member 30 and channels 47A, 47B are disposed on opposite sides of member 40. As shown in FIG. 1, in a straight configuration, fastener channel 37A in member 30 is disposed adjacent fastener channel 47A in member 40, and fastener channel 37B (not shown) of member 30 is disposed adjacent the fastener channel 47B (not shown) of member 40. In the a 90° configuration, shown in FIG. 2, channel 37A of member 30 is disposed adjacent channel 47B of member 40, and channel 37B (not shown) of member 30 is disposed adjacent channel 47A (not shown) of member 40.

Preferably, the first member 30 may be rotated with respect to the hub 24 and the second member 40 when the print head assembly 10 is adjusted. In particular, the print head assembly 10 may be adjusted from the first configuration to the second configuration by rotating the first member 30 with respect to the hub 24 and the second member 40. The member 30 is rotated around ink line 64 (and other lines, if present) to switch the print head assembly 10 from a first configuration to a second configuration.

In the a straight configuration the outer surface of the first member 30 forms a generally smooth connection with the outer surface of the second member 40, to form a generally cylindrical structure, as shown in FIG. 1.

The print head assembly 10 may provide a minimum number of connections that need to be unfastened and fastened to change configurations. In one embodiment, there are no more than two fasteners connecting the first member 30 to the second member 40. In another embodiment, there are no more than two fasteners connecting the first member 30 to the hub 24.

The procedure to change the print head configuration when the print head assembly is attached to a functioning printer is as follows. The ink stream to the print head 50 is turned off. Fasteners 51 are unfastened from threaded channels 47 in member 40 and member 40 is disconnected from member 30. Member 30 is rotated with respect to hub 24 and member 40 to change print head orientation. Member 30 is re-attached to member 40. The ink stream is turned back on and the print head 50 may begin printing. The print head assembly 10 provides the ability for no need to reprime print head because of orientation change.

The print head assembly 10 may be made of any suitable material. The members 30 and 40 are preferably made of a suitable metal, such as stainless steel. In one embodiment, the print head assembly has a length in a straight configuration of about 7.2 inches and a length in the 90° configuration of about 6 inches. The desired adjustable print head geometry can be accomplished by using many methods, such as fasteners, pivoting pins, indexing devices, motors, solenoids, or flexible membranes.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An adjustable print head assembly for an ink jet printer, comprising:
an umbilical of an ink jet printer, the umbilical comprising a center axis;
a hub connected to the umbilical;
a first member connected to the hub, the first member comprising an outer wall and an inner passage, the outer wall including a proximal end connected to the hub and a distal end with an outer surface angled at an angle with respect to the umbilical axis;
a second member comprising an outer wall and an inner passage, the outer wall including an angled surface complementary to the angled surface of the first member;
wherein the first member comprises first and second fastener channels disposed generally perpendicular to the angled surface of the first member, and wherein the second member comprises first and second fastener channels disposed generally perpendicular to the angled surface of the second member;
a print head connected to the second member, the print head including a center axis, wherein the angled surface of the second member is angled at an angle with respect to the print head axis, and disposed within the print head are a nozzle assembly and an ink valve; and
a plurality of fluid lines running from the umbilical to the print head, the plurality of fluid lines disposed through the inner passages of the first and second members, the plurality of fluid lines comprising at least one ink line, a solvent line, a return line, and a vacuum line;
wherein the print head assembly is adjustable from a first configuration to a second configuration, wherein in the first configuration, the print head axis is oriented generally parallel to the umbilical axis and the first fastener channel of the first member is disposed adjacent the first fastener channel of the second member and the second fastener channel of the first member is disposed adjacent the second fastener channel of the second member, and in the second configuration, the print head axis is oriented at a predetermined angle with respect to the umbilical axis and the first fastener channel of the first member is disposed adjacent the second fastener channel of the second member and the second fastener channel of the first member is disposed adjacent the first fastener channel of the second member, wherein the predetermined angle is determined by the angle of the angled surface of the first member with respect to the umbilical axis and the angle of the angled surface of the second member with respect to the print head axis and is between 10° and 170°.

2. The adjustable print head assembly of claim 1, wherein the print head assembly comprises a print head cover disposed over the print head.

3. The adjustable print head assembly of claim 1 wherein the predetermined angle is between 45° and 135°.

4. The adjustable print head assembly of claim 1 wherein the predetermined angle is between 80° and 100°.

5. The adjustable print head assembly of claim 1 wherein the predetermined angle is about 90°.

6. The adjustable print head assembly of claim 1 further comprising fasteners disposed through the first and second fastener channels of the first and second members to attach the first member to the second member.

7. The adjustable print head assembly of claim 1 further comprising a fastener for connecting the first member to the hub.

8. The adjustable print head assembly of claim 1 wherein the first member may be rotated with respect to the hub and the second member.

9. The adjustable print head assembly of claim 8 wherein the print head assembly may be adjusted from the first configuration to the second configuration by rotating the first member with respect to the hub and the second member.

10. The adjustable print head assembly of claim 1 wherein the outer walls of the first and second members each have outer surfaces, wherein in the first configuration the outer surface of the first member form a generally smooth connection with the outer surface of the second member, to form a generally cylindrical structure.

11. The adjustable print head assembly of claim 1 wherein there are no more than two fasteners connecting the first member to the second member.

12. The adjustable print head assembly of claim 1 wherein there are no more than two fasteners connecting the first member to the hub.

13. The adjustable print head assembly of claim 1 wherein the first member comprises a cutout portion to allow access to components of the print head.
